(19) United States
(12) Patent Application Publication
(10) Pub. No.: US 2025/0374972 A1
(43) Pub. Date: Dec. 11, 2025

(54) AEROSOL GENERATING DEVICE

(71) Applicant: KT&G CORPORATION, Daejeon (KR)

(72) Inventor: Jae Min LEE, Siheung-si (KR)

(73) Assignee: KT&G CORPORATION, Daejeon (KR)

(21) Appl. No.: 19/186,707

(22) Filed: Apr. 23, 2025

(30) Foreign Application Priority Data
Jun. 7, 2024 (KR) 10-2024-0074537

(51) Int. Cl. A24F 40/57; A24F 40/465; A24F 40/53

(52) U.S. Cl. CPC A24F 40/57; A24F 40/465; A24F 40/53

(57) ABSTRACT

An aerosol generating device including a substrate sensing unit having a capacitance that varies according to presence of an aerosol generating substrate with respect to a cavity, a heating unit configured to heat the aerosol generating substrate when the aerosol generating substrate is inserted into the cavity, and a controller configured to obtain a monitoring value of the substrate sensing unit according to a change in the capacitance of the substrate sensing unit and control the heating unit based on the monitoring value, wherein the controller is further configured to, when the aerosol generating substrate inserted in the cavity is being heated, determine whether or not the aerosol generating substrate is extracted, based on the monitoring value.

### CROSS-REFERENCE TO RELATED APPLICATION

This application is based on and claims priority under 35 U.S.C. § 119 to Korean Patent Application Nos. 10-2024-0074537, filed on Jun. 7, 2024, in the Korean Intellectual Property Office, the disclosure of which is incorporated by reference herein in its entirety.

### BACKGROUND

### 1. Field

The disclosure relates to an aerosol generating device, and more particularly, to an aerosol generating device capable of accurately determining whether or not an aerosol generating substrate is extracted.

### 2. Description of the Related Art

Recently, there is an increasing demand for alternative methods to overcome the shortcomings of general cigarettes. For example, there is an increasing demand for a system for generating aerosol by heating an aerosol generating substrate by using an aerosol generating device, rather than by burning cigarettes.

For user convenience, such an aerosol generating system may automatically heat a heating unit according to the insertion of the aerosol generating substrate and may automatically stop the heating of the heating unit according to the extraction of the aerosol generating substrate, without a user input. In addition, such an automatic heating system requires a sensor for sensing the presence or absence of the aerosol generating substrate, but such a sensor is susceptible to disturbances due to internal or external factors. Thus, in the absence of a method for accurately recognizing the aerosol generating substrate, the heating of the heating unit may be stopped even when the aerosol generating substrate is not extracted from a cavity, resulting in user inconvenience, or the heating of the heating unit may be maintained even when the aerosol generating substrate is extracted from the cavity, resulting in overheating of the device.

### SUMMARY

Technical problems to be solved by the disclosure are to provide an aerosol generating device capable of accurately determining, through a sensor, whether or not an aerosol generating substrate is extracted.

The technical problems of the disclosure are not limited to the above description, and other technical problems may be derived from the embodiments described hereinafter.

Additional aspects will be set forth in part in the description which follows and, in part, will be apparent from the description, or may be learned by practice of the presented embodiments of the disclosure.

According to an aspect of the disclosure, an aerosol generating device includes a substrate sensing unit having a capacitance that varies according to insertion and extraction of an aerosol generating substrate with respect to a cavity, a heating unit configured to heat the aerosol generating substrate when the aerosol generating substrate is inserted into the cavity, and a controller configured to obtain a monitoring value of the substrate sensing unit according to a change in the capacitance of the substrate sensing unit and control the heating unit based on the monitoring value, wherein the controller is further configured to, when the aerosol generating substrate inserted in the cavity is being heated, determine whether or not the aerosol generating substrate is extracted, based on a first amount of change in the monitoring value before a reference time point and a second amount of change in the monitoring value after the reference time point.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an aerosol generating device, according to an embodiment;

FIG. 2 is a view illustrating an aerosol generating device, according to another embodiment;

FIG. 3 is a front perspective view illustrating an aerosol generating device, according to embodiments;

FIG. 4 is a cross-sectional view illustrating that an upper case and a body of an aerosol generating device are coupled to each other, according to an embodiment;

FIG. 5 is a diagram illustrating a sensing unit according to an embodiment;

FIG. 6 is an internal block diagram of an aerosol generating device according to an embodiment;

FIG. 7 is a diagram illustrating changes in a monitoring value according to various events;

FIG. 8 is a diagram illustrating a method of determining a reference time point, according to an embodiment;

FIG. 9 is a diagram illustrating changes in a monitoring value for events other than an extraction event according to an embodiment;

FIG. 10 is a diagram illustrating changes in a monitoring value according to an extraction event according to an embodiment; and

FIG. 11 is a flowchart illustrating an operating method of an aerosol generating device according to an embodiment.

### DETAILED DESCRIPTION

Hereinafter, embodiments of the disclosure will be described in detail with reference to the attached drawings. Regardless of the drawing symbols, identical or similar components will be given the same reference numerals and redundant descriptions thereof will be omitted.

The suffixes ‘module’ and ‘unit’ may be used for elements in order to facilitate the disclosure. Significant meanings or roles may not be given to the suffixes themselves and it is understood that the ‘module’ and ‘unit’ may be used together or interchangeably.

Also, in descriptions of embodiments of the disclosure, if it is determined that detailed description of a related known technology may obscure the gist of embodiments of the disclosure, the detailed descriptions thereof are omitted. Also, the attached drawings are only intended to facilitate easy understanding of the embodiments disclosed in the present specification, and the technical ideas disclosed in the present specification are not limited by the attached drawings, and should be understood to include all modifications, equivalents, or substitutes included in the spirit and technical scope of the disclosure.

While such terms as “first,” “second,” etc., may be used to describe various elements, such elements must not be limited to the above terms. The above terms may be used only to distinguish one element from another.

It is to be understood that when an element is described as being “on” or “in contact with” another element, it is to be understood that other elements may directly contact or be directly connected to the other element or intervening element may be present therebetween. On the other hand, when an element is described as being “directly on” or “directly in contact with” another element, it may be understood that there is no other element therebetween.

An expression used in the singular encompasses the expression of the plural, unless it has a clearly different meaning in the context.

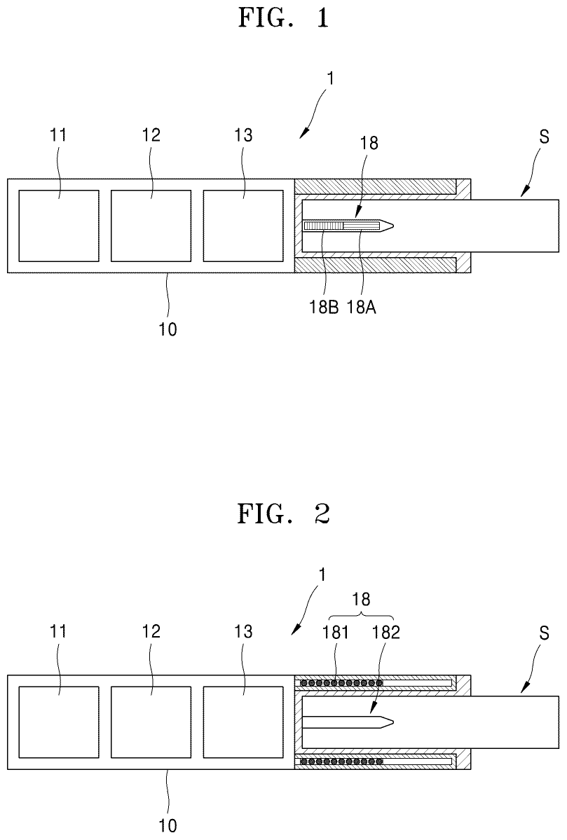

FIG. 1 is a view illustrating an aerosol generating device, according to an embodiment. FIG. 2 is a view illustrating an aerosol generating device, according to another embodiment.

Referring to FIGS. 1 and 2, the aerosol generating device 1 according to embodiments may include at least one of a battery 11, a controller 12, a sensing unit 13, and a heater 18. At least one of the battery 11, the controller 12, the sensing unit 13, and the heater 18 may be disposed inside a body 10 of the aerosol generating device 1. The body 10 may provide a space that is open upward so that an aerosol generating substrate S, which is an aerosol generating article, is inserted. The space that is open upward may be referred to as an insertion space or a cavity. The insertion space may be recessed by a certain depth toward the inside of the body 10 so that at least a part of the aerosol generating substrate S is inserted. A depth of the insertion space may correspond to a length of an area where an aerosol generating material and/or medium is included in the aerosol generating substrate S. A lower end of the aerosol generating substrate S may be inserted into the body 10, and an upper end of the aerosol generating substrate S may protrude outward from the body 10. A user may inhale air while holding the upper end of the aerosol generating substrate S that is exposed to the outside in his mouth. According to an embodiment, the aerosol generating device 1 may further include a vaporizer (not illustrated), and aerosol generated by the vaporizer may pass through the aerosol generating substrate S and be delivered to the user. To this end, the vaporizer may include a liquid storage, a liquid delivery element, and an additional heating element.

The heater 18 may heat the aerosol generating substrate S. The heater 18 may extend long upward in the space into which the aerosol generating substrate S is inserted. For example, the heater 18 may include a tube-type heating element, a plate-type heating element, a needle-type heating element, or a rod-type heating element. The heater 18 may be inserted into a lower portion of the aerosol generating substrate S. According to an embodiment, the heater 18 may include a cylinder-type heating element, unlike FIGS. 1 and 2, and the cylinder-type heating element may accommodate the aerosol generating substrate S and may heat at least a portion of an outer surface of the aerosol generating substrate S.

The heater 18 may include an electro-resistive heater and/or an induction heater.

For example, referring to FIG. 1, the heater 18 may be a resistive heater. For example, the heater 18 may include an electrically conductive track, and the heater 18 may be heated as current flows through the electrically conductive track. The heater 18 may be electrically connected to the battery 11. The heater 18 may directly generate heat by receiving current from the power supply unit 101. Because the heater 18 is a component for heating the aerosol generating substrate S, the heater 18 may also be referred to as a heating unit 180.

For example, the heater 18 may be a multi-heater. The heater 18 may include a first heater 18A and a second heater 18B. The first and second heaters 18A and 18B may be arranged side by side in a longitudinal direction of the aerosol generating device 1. The first and second heaters 18A and 18B may be heated sequentially or simultaneously.

For example, referring to FIG. 2, the aerosol generating device 1 may include an induction coil 181 surrounding a susceptor 182. The induction coil 181 may cause the susceptor 182 to generate heat. In an embodiment in which the heater 18 of the aerosol generating device 1 is an induction heater, the induction coil 181 and the susceptor 182 may be referred to as the heater 18. In an embodiment, only the susceptor 182 may be referred to as the heater 18. In addition, because the induction coil 181 and the susceptor 182 contribute to heating, the induction coil 181 and the susceptor 182 may also be referred to as the heating unit 180.

The susceptor 182 may generate heat by a magnetic field generated by an alternating current (AC) flowing through the induction coil 181. The magnetic field may penetrate the susceptor 182 and generate an eddy current within the susceptor 182. The current may generate heat in the susceptor 182. The susceptor 182 may be a tube-type heating element, a plate-type heating element, a needle-type heating element, or a rod-type heating element, as in FIG. 2. However, according to an embodiment, the susceptor 182 may have a cylindrical shape, may accommodate the aerosol generating substrate S, and may heat at least a portion of the outer surface of the aerosol generating substrate S. In addition, according to an embodiment, the susceptor 182 may be a component included in the aerosol generating substrate S, rather than in the aerosol generating device 1.

The battery 11 may supply power so that components of the aerosol generating device 1 operate. The battery 11 may supply power to at least one of the controller 12, the sensing unit 13, and the heater 18.

The controller 12 may control an overall operation of the aerosol generating device 1. The controller 12 may be mounted on a printed circuit board (PCB). The controller 12 may control an operation of at least one of the battery 11, the sensing unit 13, and the heater 18. The controller 12 may control an operation of the induction coil 181. The controller 12 may control operations of a display, a motor, etc. provided in the aerosol generating device 1. The controller 12 may check a state of each of the components of the aerosol generating device 1 to determine whether the aerosol generating device 1 is operable.

The controller 12 may analyze a result detected by the sensing unit 13 and may control processes to be performed later. For example, the controller 12 may control power supplied to the heater 18 so that an operation of the heater 18 starts or ends, based on the result detected by the sensing unit 13. For example, the controller 12 may control the amount of power supplied to the heater 18 or a time for which power is supplied so that the heater 18 is heated to a certain temperature or maintained at an appropriate temperature, based on the result detected by the sensing unit 13.

The sensing unit 13 may include at least one of a temperature sensor, a puff sensor, an insertion detection sensor, and an acceleration sensor. For example, the sensing unit 13 may sense at least one of the temperature of the heater 18, the temperature of the battery 11, and the internal/external temperature of the body 10. For example, the sensing unit 13 may sense a user puff. For example, the sensing unit 13 may sense whether or not the aerosol generating substrate S is inserted into the insertion space. For example, the sensing unit 13 may sense the movement of the aerosol generating device 1.

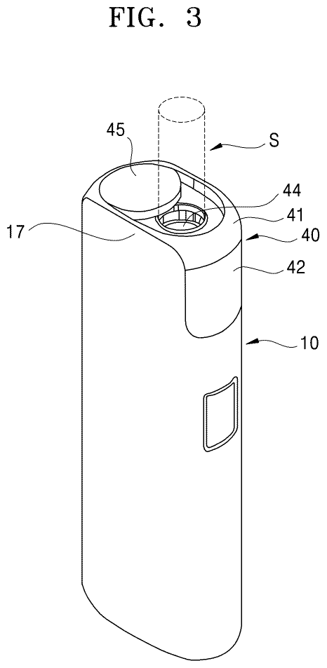

FIG. 3 is a front perspective view of an aerosol generating device according to embodiments.

Although a case in which the heater 18 is an induction heater is mainly described with reference to FIG. 3 and the following drawings, the following description may also apply to the case of the electro-resistive heater of FIG. 1.

Referring to FIG. 3, an upper case 40 may be detachably coupled to the body 10. The upper case 40 may be coupled to an upper side of the body 10. The upper case 40 may cover an upper periphery of the body 10. The upper case 40 may include an insertion hole 44. The aerosol generating substrate S may be inserted into the insertion hole 44. The insertion hole 44 may be a component corresponding to the insertion space or cavity described with reference to FIGS. 1 and 2. The upper case 40 may include a cover 45 that opens and closes the insertion hole 44. The cover 45 may slide in a transverse direction to open and close the insertion hole 44.

The upper case 40 may include an upper case wing 42. The upper case wing 42 may extend downward from both sides of an upper case body 41. The upper case wing 42 may be referred to as an upper case grip 42.

The body 10 may include a body wing 17. The body wing 17 may extend upward from an upper edge of the body 10. The body wing 17 may be formed as a pair of body wings 17 facing each other with respect to an upper portion of the body 10. The body wing 17 may be formed at a position misaligned with the upper case wing 42.

When the upper case 40 is coupled to the body 10, the upper case 40 may form an upper exterior of the aerosol generating device 1. When the upper case 40 is coupled to the body 10, the body wing 17 may cover a side portion of the upper case 40 that is exposed between the upper case wings 42. When the upper case 40 is coupled to the body 10, the upper case wing 42 may cover an outer wall of the body 10.

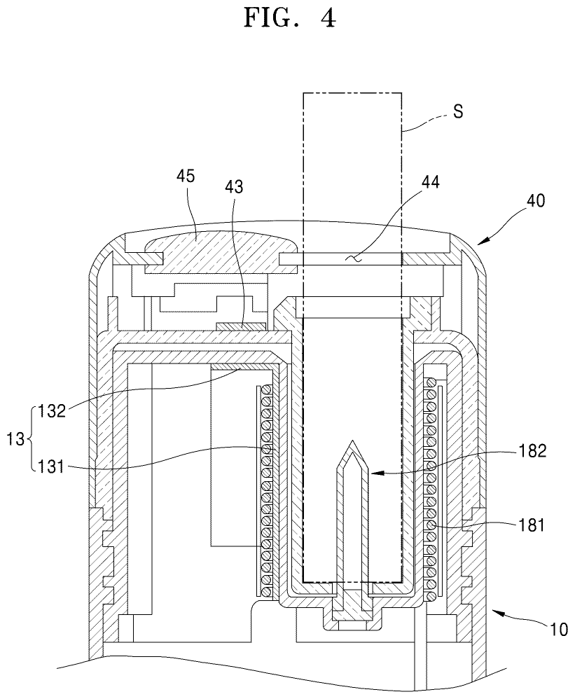

FIG. 4 is a cross-sectional view illustrating that an upper case and a body of an aerosol generating device are coupled to each other, according to an embodiment.

Referring to FIG. 4, the upper case 40 may be detachably coupled to the body 10. The upper case 40 may include the insertion hole 44. The cover 45 may be movably installed on the upper case 40 to open or close the insertion hole 44.

When the insertion hole 44 is opened, the aerosol generating substrate S may be accommodated into the aerosol generating device 1 through the insertion hole 44. The susceptor 182 may be fixed to the body 10 or, according to an embodiment, may be replaceably coupled to the body 10. When the aerosol generating substrate S is accommodated into the aerosol generating device 1 through the insertion hole 44, the susceptor 182 may be inserted into the aerosol generating substrate S.

The induction coil 181 may surround an outer peripheral surface of an accommodation space forming the insertion hole 44 and may generate a variable magnetic field by AC power. The variable magnetic field may be provided to the susceptor 182, and the susceptor 182 may be inductively heated by the variable magnetic field.

The sensing unit 13 may include a substrate sensing unit 131 and an upper case sensing unit 132. The substrate sensing unit 131 and the upper case sensing unit 132 may be formed as a single body.

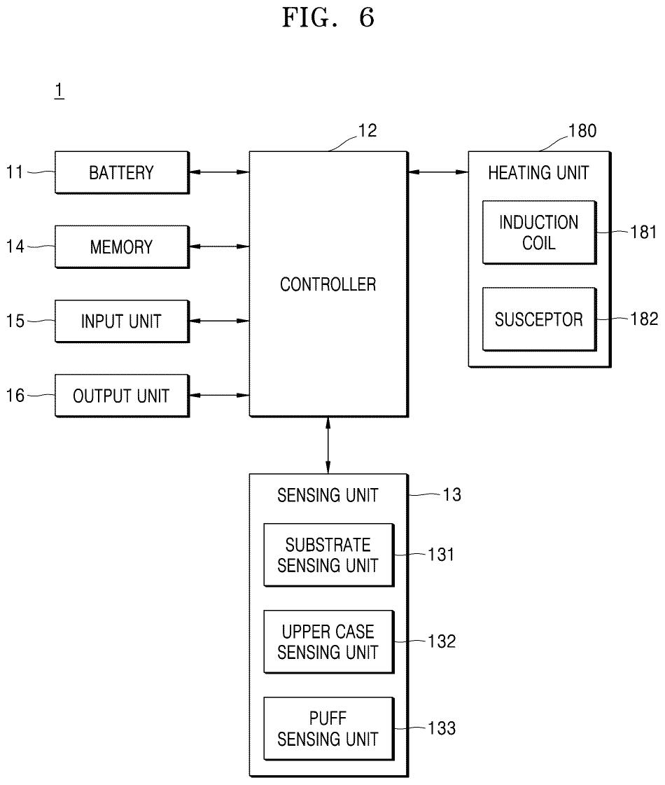

The substrate sensing unit 131 may be arranged between the outer peripheral surface of the accommodation space and the induction coil 181 and may sense the presence or absence of the aerosol generating substrate S inserted into the accommodation space through the insertion hole 44. The substrate sensing unit 131 may be manufactured as a thin film so as to be arranged between the accommodation space and the induction coil 181. The substrate sensing unit 131 may surround at least a portion of the outer peripheral surface of the accommodation space, and an output value of the substrate sensing unit 131 may vary according to the insertion of the aerosol generating substrate S. In addition, the substrate sensing unit 131 may transmit the output value to the controller 12 (see FIG. 6).

The upper case sensing unit 132 may be connected to and formed as a single body with the substrate sensing unit 131. The upper case sensing unit 132 may be disposed in the body 10 and is arranged inside the surface where the upper case 40 contacts the body 10, extending in a direction. The direction may be perpendicular to an insertion direction of the aerosol generating substrate S. The upper case 40 may include at least one conductor 43 in a portion thereof that contacts the upper case sensing unit 132, and the upper case sensing unit 132 may output an output value that varies according to the approach and retreat of the at least one conductor 43. The upper case sensing unit 132 may transmit the output value to the controller 12.

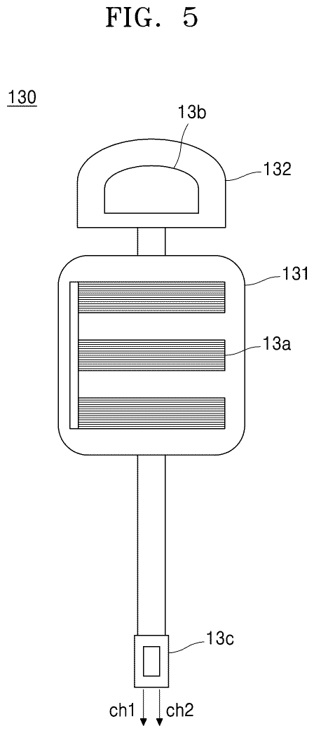

FIG. 5 is a diagram illustrating a sensing unit according to an embodiment.

Referring to FIG. 5, the upper case sensing unit 132 and the substrate sensing unit 131 may be formed as a single body. The integrated upper case sensing unit 132 and substrate sensing unit 131 may be referred to as the sensing module 130. The upper case sensing unit 132 and the substrate sensing unit 131 may be implemented in a pattern shape on an insulating substrate. For example, the upper case sensing unit 132 and the substrate sensing unit 131 may each be implemented in a pattern shape on a single flexible printed circuit board (FPCB).

The upper case sensing unit 132 may include an inductive sensor. In an embodiment in which the upper case sensing unit 132 includes an inductive sensor, the upper case sensing unit 132 may include a sensing coil 13b. The sensing coil 13b may be implemented in a pattern shape on the insulating substrate. The inductance of the substrate sensing unit 131 may vary according to the approach and retreat of the upper case 40, and the substrate sensing unit 131 may transmit a varied inductance value to the controller 12. To this end, the sensing unit 13 may further include a signal transmission unit 13c. The signal transmission unit 13c may include a first channel ch1 and a second channel ch2 and may transmit the varied inductance value to the controller 12 through the first channel ch1.

The controller 12 may determine, based on an inductance value output by the upper case sensing unit 132, whether or not the upper case 40 is mounted on the body 10. For example, when the amount of change in inductance per unit time output by the upper case sensing unit 132 is greater than or equal to a preset reference inductance, the controller 12 may determine that the upper case 40 is mounted on the body 10.

The substrate sensing unit 131 may include at least one capacitor sensor. In an embodiment in which the substrate sensing unit 131 includes a capacitor sensor, the substrate sensing unit 131 may include at least one electrode 13a. Although FIG. 5 illustrates an embodiment in which three electrodes 13a are provided, the number of electrodes 13a is not limited thereto. The electrode 13a may be implemented in a pattern shape on the insulating substrate. The electrode 13a may contact the outer peripheral surface of the accommodation space and may surround at least a portion of the outer peripheral surface of the accommodation space. According to an embodiment, the sensing unit 13 may be externally coated, and the externally coated layer of the sensing unit 13 may directly contact the outer peripheral surface of the accommodation space.

Because the electrode 13a surrounds the accommodation space, the accommodation space may be understood as a dielectric space that causes a change in capacitance. In other words, when the aerosol generating substrate S is inserted into the accommodation space, the dielectric constant of the electrode 13a may vary, and the capacitance of the substrate sensing unit 131 may vary. As such, the substrate sensing unit 131 may not include separate transmitting and receiving electrodes and may output a capacitance value that varies according to a change in the capacitance of the electrode 13a itself. The substrate sensing unit 131 may transmit the capacitance value to the controller 12. The signal transmission unit 13c may transmit the capacitance value to the controller 12 through the second channel ch2 that is different from the first channel ch1.

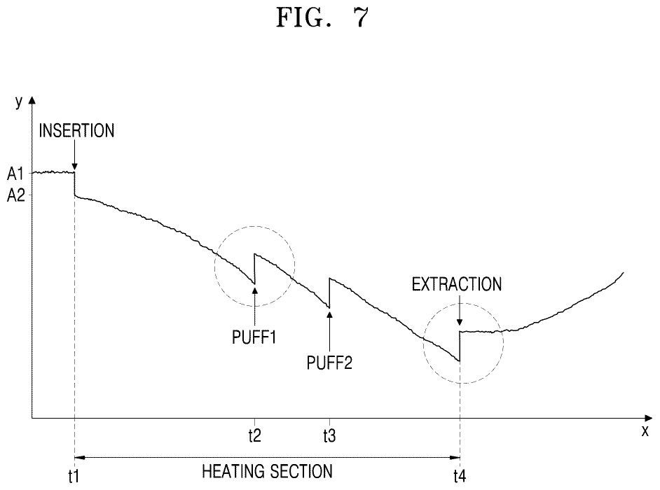

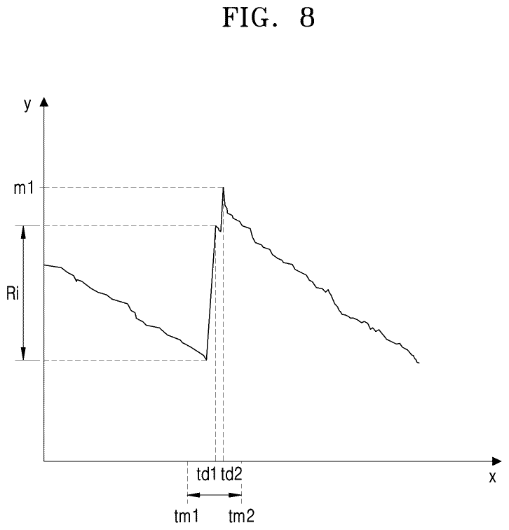

The controller 12 may determine, based on the capacitance value output by the substrate sensing unit 131, the presence or absence of the aerosol generating substrate S inserted into the accommodation space. For example, the controller 12 may obtain a monitoring value according to a change in the capacitance of the substrate sensing unit 131 and may determine, based on the monitoring value, the presence or absence of the aerosol generating substrate S inserted into the accommodation space. The monitoring value may include the charging time, the discharging time, the number of charge/discharge cycles, and the amount of change in capacitance of the electrode 13a according to the change in capacitance of the substrate sensing unit 131. For example, when the monitoring value is decreased by an amount greater than or equal to a reference decrease amount within a preset time period, the controller 12 may determine that the aerosol generating substrate S is inserted into the cavity. A method of determining whether or not the aerosol generating substrate S is extracted from the cavity when the aerosol generating substrate S is heated is described with reference to FIG. 7 and the following drawings.

FIG. 6 is an internal block diagram of an aerosol generating device according to an embodiment.

Referring to FIG. 6, the aerosol generating device 1 may include at least one of the battery 11, the heating unit 180, the sensing unit 13, the controller 12, a memory 14, an input unit 15, and an output unit 16. The aerosol generating device 1 of the disclosure may further include other general-purpose components, in addition to the components illustrated in FIG. 6. For example, the aerosol generating device 1 may further include a communication unit (not illustrated) for communicating with an external device.

The battery 11 supplies power used by the aerosol generating device 1 to operate. For example, the battery 11 may supply power to at least one of the heating unit 180, the sensing unit 13, the controller 12, the memory 14, the input unit 15, and the output unit 16. The aerosol generating device 1 may further include a power conversion unit (not illustrated) to supply power to the internal components of the aerosol generating device 1. The power conversion unit may include a DC/DC converter. The DC/DC converter may supply power to the internal components of the aerosol generating device 1 by boosting or lowering DC power supplied from the battery 11. When the heating unit 180 is an induction heater, the aerosol generating device 1 may further include a DC/AC converter. The DC/AC converter may convert the DC power supplied from the battery 11 into AC power and may supply the AC power to the heating unit 180.

The battery 11 may include a removable battery that is detachably arranged in the aerosol generating device 1. Alternatively, the battery 11 may be fixed to the aerosol generating device 1. In this case, the battery 11 may be rechargeable or disposable. For example, the battery 11 may be a lithium polymer (LiPoly) battery, but is not limited thereto.

The heating unit 180 may include the induction coil 181 and the susceptor 182. The induction coil 181 may generate a variable magnetic field when supplied with AC power. The susceptor 182 may be heated by the variable magnetic field, thereby generating aerosol.

The sensing unit 13 may sense various state information of the aerosol generating device 1. A result sensed by the sensing unit 13 may be transmitted to the controller 12, and the controller 12 may, according to the sensed result, control the aerosol generating device 1 to perform various functions, such as controlling the operation of the heating unit 180, restricting smoking, determining whether or not the heating unit 180 is inserted, and displaying a notification.

The sensing unit 13 may include the substrate sensing unit 131, the upper case sensing unit 132, and a puff sensing unit 133.

The substrate sensing unit 131 and the upper case sensing unit 132 may each be implemented in a pattern shape on one insulating substrate. The substrate sensing unit 131 may include a capacitance sensor including at least one electrode 13a. Therefore, the capacitance of the substrate sensing unit 131 may vary according to the insertion and extraction of the aerosol generating substrate S with respect to the cavity. The substrate sensing unit 131 may transmit a capacitance value to the controller 12 in real time or periodically.

The upper case sensing unit 132 may include an inductive sensor. Therefore, the inductance of the upper case sensing unit 132 may vary according to the approach and retreat of the upper case 40 to and from the body 10. The upper case sensing unit 132 may transmit an inductance value to the controller 12 in real time or periodically.

The puff sensing unit 133 may sense a user puff. To this end, the puff sensing unit 133 may include a pressure sensor, a flow sensor, an airflow sensor, and a microphone.

The sensing unit 13 in FIG. 6 includes components related to the present embodiment. Therefore, it will be understood by one of ordinary skill in the art related to the present embodiment that other general-purpose components may be further included in the sensing unit 13, in addition to the components illustrated in FIG. 6. For example, the sensing unit 13 may further include a water detection sensor for sensing water inside and/or outside the aerosol generating device 1, a battery temperature sensor, etc.

The memory 14 may be a hardware component for storing various pieces of data processed in the aerosol generating device 1, and the memory 14 may store data processed or to be processed by the controller 12. The memory 14 may include various types of memories, such as random access memory, such as dynamic random access memory (DRAM), static random access memory (SRAM), etc., read-only memory (ROM), electrically erasable programmable read-only memory (EEPROM), etc. In an embodiment, the memory 14 may store a capacitance value output by the substrate sensing unit 131 in real time. Alternatively, the memory 14 may store a monitoring value of the substrate sensing unit 131, which is obtained by the controller 12, in real time. The capacitance value and the monitoring value stored in the memory 14 may be used to calculate the amount of change for each value before and after a reference time point.

The input unit 15 may receive a user input. The input unit 15 may be implemented as a physical key and/or a touch sensor for receiving a user input. According to an embodiment, the input unit 15 may be omitted, and in this case, the heating of the heating unit 180 may be enabled by inhalation by the user. For example, the input unit 15 may include a button, a key pad, a dome switch, a jog wheel, a jog switch, etc., but is not limited thereto.

The output unit 16 may include a display for outputting visual information related to the aerosol generating device 1. In addition, the output unit 16 may include a motor for outputting tactile information related to the aerosol generating device 1. Here, the visual and tactile information related to the aerosol generating device 1 includes all types of information related to the operation of the aerosol generating device 1. For example, the output unit 16 may visually and tactilely output information about the insertion and extraction of the aerosol generating substrate S through certain elements. To this end, the output unit 16 may include a display and a haptic motor. The display may include a liquid crystal display (LCD) panel and an organic light-emitting display (OLED) panel. When the display and a touch pad form a layer structure to thereby form a touch screen, the display may be used as an input device, in addition to an output device. The haptic motor may convert an electric signal to a mechanical stimulus or an electrical stimulus and may tactilely provide the information about the aerosol generating device 1 to the user.

The controller 12 controls general operations of the aerosol generating device 1. In an embodiment, the controller 12 may include at least one processor. The processor may be implemented as an array of a plurality of logic gates or may be implemented as a combination of a general-purpose microprocessor and a memory in which a program executable in the microprocessor is stored. It will be understood by one of ordinary skill in the art that the processor may be implemented in other forms of hardware.

When the aerosol generating substrate S is inserted into the cavity, the controller 12 may control the heating unit 180 to heat the aerosol generating substrate S. In an embodiment, the controller 12 may control DC power output from the battery 11 or AC power supplied to the induction coil 181, so that the induction coil 181 may generate a variable magnetic field. The susceptor 182 may be heated by the variable magnetic field generated by the induction coil 181, thereby generating aerosol. As such, the aerosol generating device 1 of the disclosure may automatically heat the aerosol generating substrate S when the aerosol generating substrate S is inserted into the cavity, without a user input.

The automatic heating of the aerosol generating substrate S is possible only when the upper case sensing unit 132 senses the upper case 40. In other words, the controller 12 determines whether or not the upper case 40 is mounted on the body 10, based on an inductance value provided by the upper case sensing unit 132 through the first channel ch1. Even when the controller 12 receives a capacitance value greater than a reference change amount provided by the substrate sensing unit 131 through the second channel ch2, before determining that the upper case 40 is mounted on the body 10, the controller 12 may not automatically heat the aerosol generating substrate S. This is to prevent the heating unit 180 from being heated by mistake even when the aerosol generating substrate S is not inserted into the cavity.

In a state in which the upper case 40 is mounted on the body 10, when the substrate sensing unit 131 senses the aerosol generating substrate S inserted into the cavity, the controller 12 may control the heating unit 180 to heat the aerosol generating substrate S. In addition, in a state in which the aerosol generating substrate S is heated, when the substrate sensing unit 131 senses the extraction of the aerosol generating substrate S, the controller 12 may cut off power supplied to the heating unit 180.

When the substrate sensing unit 131 includes a capacitance sensor and is arranged adjacent to the heating unit 180, a capacitance output value is gradually decreased over time according to the heating of the heating unit 180 even when no specific event occurs. This occurs due to an increase in the temperature of the capacitance sensor due to the heating of the heating unit 180. In the disclosure, whether or not the aerosol generating substrate S is extracted may be accurately determined by using an output change trend of the capacitance sensor according to the heating of the heating unit 180. The change trend may be performed by comparing the amount of change before a reference time point and the amount of change after the reference time point.

In detail, the controller 12 may obtain a monitoring value of the substrate sensing unit 131 according to a change in the capacitance of the substrate sensing unit 131 and may control the heating unit 180 based on the monitoring value. In addition, in a state in which an aerosol generating substrate S is inserted into the cavity and the aerosol generating substrate S is heated, the controller 12 may determine whether or not the aerosol generating substrate is extracted, based on a first amount of change in the monitoring value before a reference time point and a second amount of change in the monitoring value after the reference time point. The output change trend of the capacitance sensor according to various events is described with reference to FIG. 7, and a comparison of the amounts of change before and after the reference time point is described with reference to FIGS. 7 to 9.

FIG. 7 is a diagram illustrating changes in a monitoring value according to various events.

In FIG. 7, an x-axis represents time (sec), and a y-axis represents a monitoring value of the substrate sensing unit 131 according to a change in the capacitance of the substrate sensing unit 131. The monitoring value may be a capacitance value itself output by the substrate sensing unit 131, but may also be at least one of the charging time, the discharging time, and the number of charge/discharge cycles of the electrode 13a. In an embodiment, the monitoring value may be at least one or a combination of the capacitance value itself, the charging time, the discharging time, and the number of charge/discharge cycles, which may be determined according to manufacturing specifications of the substrate sensing unit 131 and the controller 12 or may be selected from the above-described monitoring values to clearly distinguish the capacitance change amount trend.

Referring to FIG. 7, the aerosol generating substrate S is inserted at a first time point t1. Because the heating unit 180 is not heated before the first time point t1, the monitoring value of the substrate sensing unit 131 does not substantially change from an initial value A1.

When the aerosol generating substrate S is inserted at the first time point t1, the dielectric constant inside the accommodation space changes rapidly, and thus, the monitoring value also changes rapidly. For example, when the aerosol generating substrate S is inserted, the dielectric constant of the accommodation space is rapidly increased, and thus, the overall monitoring value is decreased. FIG. 7 illustrates an example in which the monitoring value is decreased from the initial value A1 to a changed value A2. When the monitoring value is decreased by an amount greater than or equal to a reference decrease amount within a preset time period, the controller 12 may determine that the aerosol generating substrate S is inserted into the cavity. In FIG. 7, the amount of decrease is the initial value A1−the changed value A2, and the controller 12 determines that the amount of decrease is greater than or equal to the reference decrease amount, and thus determines that the aerosol generating substrate S is inserted into the cavity. The reference decrease amount may be appropriately set according to the capacitance of the substrate sensing unit 131 and target values of the monitoring value. For example, when the monitoring value is the number of charge/discharge cycles of the electrode 13a per unit time (sec), the reference decrease amount may be selected in a range of about 15,000 to about 22,000.

When the aerosol generating substrate S is inserted into the cavity at the first time point t1, the controller 12 controls the heating unit 180 to heat the aerosol generating substrate S. The heating of the aerosol generating substrate S continues from the first time point t1 to a fourth time point t4 at which the aerosol generating substrate S is extracted. The section from the first time point t1 to the fourth time point t4 may be referred to as a heating section.

In the heating section, the user performs a puff. A user puff may be determined based on an output value of the puff sensing unit 133. In FIG. 7, a first puff Puff 1 is sensed at a second time point t2 and a second puff Puff 2 is sensed at a third time point t3. The dielectric constant of the accommodation space may be varied by the user puff. This occurs due to the vaporization of a material included in the aerosol generating substrate S, the release of an aerosol source into the accommodation space, and the inflow of airflow due to the user puff. In particular, at the time point at which the user puff occurs, the monitoring value is temporarily increased rapidly due to the vaporization of an aerosol source and the inflow of airflow, which affect the dielectric constant. However, in the case of the user puff, because the heating unit 180 is still heated, the monitoring value of the substrate sensing unit 131 is temporarily increased and then gradually decreased again. This may be observed in both the first puff Puff 1 and the second puff Puff 2.

When the aerosol generating substrate S is extracted from the cavity at the fourth time point t4, like at the first time point t1, the dielectric constant inside the accommodation space changes rapidly, and thus, the monitoring value also changes rapidly. However, at the fourth time point t4, due to extraction of the aerosol generating substrate S, the dielectric constant of the accommodation space is rapidly decreased, and thus, the overall monitoring value is increased. When the aerosol generating substrate S is extracted from the cavity, the controller 12 cuts off power supplied to the heating unit 180. Unlike the case of the user puff in the heating section, when the aerosol generating substrate S is extracted from the cavity, because the heating unit 180 is no longer heated, the monitoring value of the substrate sensing unit 131 is rapidly increased at the fourth time point t4, which is the extraction time point, maintained at the same value for a certain period of time, and then gradually increased over time. As the temperature of the heating unit 180 is decreased, the monitoring value of the substrate sensing unit 131 may be increased to the initial value A1.

As described above, in the cases of a user puff event and an extraction event, there are clear differences in monitoring values between sections before and after the time point at which each event occurs. In the disclosure, whether or not the aerosol generating substrate S is extracted is accurately determined based on the change trend of monitoring values before and after the time point at which such an event occurs.

The heating section of the disclosure may be divided into a preheating section and a smoking section after the preheating section, and the determination of whether or not the aerosol generating substrate S is extracted may be performed in the smoking section. This is because, while the monitoring value is rapidly decreased in the preheating section, which is the initial stage of heating, such a rapid change in the monitoring value does not appear in the smoking section, allowing a more accurate change trend in the monitoring value to be observed.

FIG. 8 is a diagram illustrating a method of determining a reference time point, according to an embodiment.

Referring to FIG. 8, the reference time point is a time point at which a sudden change in the monitoring value occurs and may refer to a time point at which an event occurs. In a state in which the aerosol generating substrate S is heated, the event may refer to a puff event and an extraction event, which may cause a rapid change in dielectric constant. Although only a method of setting a puff event occurrence time point is described with reference to FIG. 8, the following description may also apply to a method of setting an extraction event occurrence time point.

In a state in which the aerosol generating substrate S is heated, the controller 12 may obtain a monitoring value for the substrate sensing unit 131. The controller 12 may set the reference time point based on the monitoring value that is increased by an amount greater than or equal to a reference increase amount Ri.

The memory 14 store the monitoring value in real time, and the controller 12 may read the monitoring value from the memory 14 and determine whether or not the monitoring value is increased by an amount greater than or equal to the reference increase amount Ri during a preset time period. In FIG. 8, the controller 12 obtains the monitoring value that is increased by an amount greater than or equal to the reference increase amount Ri at a first observation time point td1.

The controller 12 may set a monitoring section extending before and after a reaching time point, at which the amount of increase in the monitoring value reaches the reference increase amount Ri, and including the reaching time point. In FIG. 8, the first observation time point td1 indicates the reaching time point, and the monitoring section (tm1−tm2) is set to extend before and after the first observation time point td1. The monitoring section may include equal sections before and after the first observation time point td1. In other words, in FIG. 8, the length from the first observation time point td1 to a first monitoring time tm1 may be equal to the length from the first observation time point td1 to a second monitoring time tm2.

The controller 12 may set the time point at which the monitoring value reaches a maximum value in the monitoring section (tm1−tm2) as the reference time point. In FIG. 8, the maximum value of the monitoring value in the monitoring section (tm1−tm2) is a first monitoring value m1, which is reached at a second observation time point td2. The controller 12 may set the second observation time point td2 as the reference time point.

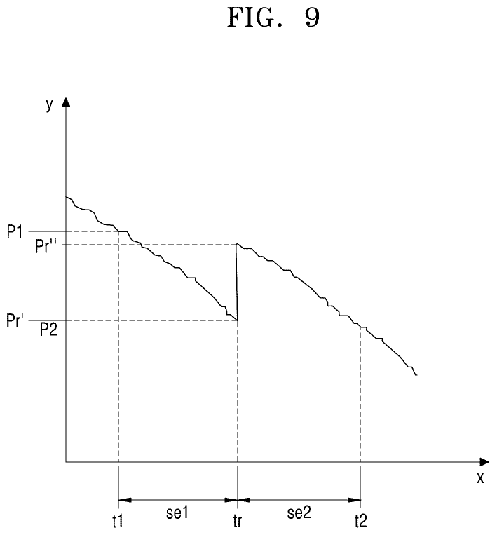

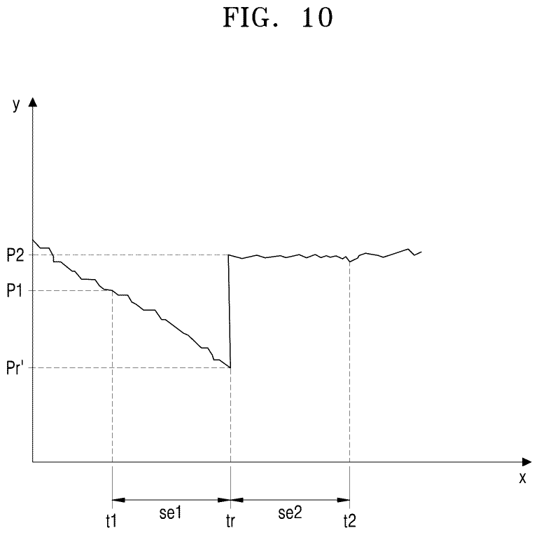

In the disclosure, a global peak may be specified by setting the monitoring section based on the time point at which the reference increase amount Ri is reached. Therefore, the exact time point at which an event occurs may be determined. For convenience of description, the reference time points in FIGS. 9 and 10 below only illustrates simplified representations of the global peak described with reference to in FIG. 8, but local peaks may also be included in FIGS. 9 and 10 below.

FIG. 9 is a diagram illustrating changes in monitoring values for events other than an extraction event according to an embodiment.

FIG. 9 is an enlarged view of the first puff Puff 1 portion in FIG. 7 as an event other than the extraction event.

Referring to FIG. 9, the controller 12 may set a reference time point tr. The reference time point tr is the same as described with reference to FIG. 8.

The controller 12 may obtain a first amount of change in the monitoring value of the substrate sensing unit 131 in a first section se1 selected between a first time point t1 before the reference time point tr and the reference time point tr. The length of the first section se1 is set to be selectable between the first time point t1 and the reference time point tr so that the local peak portion is not included in the change amount calculation portion, as shown in FIG. 8. However, it is not necessary that the length of the first section se1 be less than the length from the first time point t1 to the reference time point tr. FIG. 9 illustrates an example in which the length of the first section se1 is equal to the length between the first time point t1 and the reference time point tr.

The controller 12 may obtain a second amount of change in the monitoring value of the substrate sensing unit 131 in a second section se2 selected between the reference time point tr and a second time point t2 after the reference time point. The reason for setting the range of the second section se2 is the same as the reason for setting the range of the first section se1.

The first section se1 and the second section se2 may have the same length. This is to observe the change trend of the monitoring value under the same conditions.

When the first amount of change is gradually decreased over time in the first section se1 and the second amount of change is gradually decreased over time in the second section se2, the controller 12 determines that the aerosol generating substrate S is not extracted from the cavity.

A decrease in the amount of change over time may be obtained from a decrease in the amount of change per unit time. This may be calculated by linearly approximating the monitoring value of the first section se1. For example, when the monitoring value is P1 at the first time point t1, which is the start of the first section se1, and the monitoring value is Pr′ at the reference time point tr, which is the end of the first section se1, the first amount of change in the first section se1 may be obtained from (Pr′−P1)/(tr−t1), which is a linear slope value. Likewise, the monitoring value of the second section se2 may also be linearly approximated, and in this case, the second amount of change in the second section se2 may be obtained from (P2−Pr″)/(t2−tr).

When the amount of change per unit time is less than a preset reference value in both the first section se1 and the second section se2, the controller 12 determines that the first amount of change and the second amount of change are gradually decreased over time, and thus determines that the aerosol generating substrate S is not extracted from the cavity. When the first amount of change and the second amount of change are linearly approximated, the reference value may be a reference slope. In other words, when the first amount of change and the second amount of change are less than the reference slope (however, in this case, all slopes are negative numbers), the controller 12 may determine that the aerosol generating substrate S is not extracted from the cavity.

When the aerosol generating substrate S is not extracted from the cavity, the controller 12 may maintain the heating of the heating unit 180.

FIG. 10 is a diagram illustrating changes in a monitoring value according to an extraction event according to an embodiment.

The reasons for setting the reference time point tr, the first section se1, and the second section se2 are the same as described with reference to FIG. 9. In addition, the description regarding the decrease in the amount of change provided with reference to FIG. 9 also applies to FIG. 10.

Referring to FIG. 10, when the first amount of change is gradually decreased over time in the first section se1 and the second amount of change is maintained within a reference range in the second section se2, the controller 12 may determine that the aerosol generating substrate S is extracted from the cavity.

Like in FIG. 9, the amount of change in the first section se1 may be obtained from a linear approximation value of the monitoring value, and the first amount of change in the first section se1 may be obtained from (Pr′−P1)/(tr−t1), which is a linear slope value. The controller 12 may compare the reference slope with the first amount of change, and when the first amount of change is less than the reference slope (however, in this case, all slopes are negative numbers), the controller 12 may continue to obtain the second amount of change in the second section se2.

When the second amount of change in the second section se2 is maintained within the reference range, because the first amount of change and the change trend of the monitoring value are different, the controller 12 may determine that the aerosol generating substrate S is extracted from the cavity. In an embodiment in which the monitoring value is the number of charge/discharge cycles, the reference range may be 500 times, but is not limited thereto. When the second amount of change is linearly approximated, the slope of the second amount of may be substantially flat, and the controller 12 may determine, through such a change in slope, whether or not the aerosol generating substrate S is extracted.

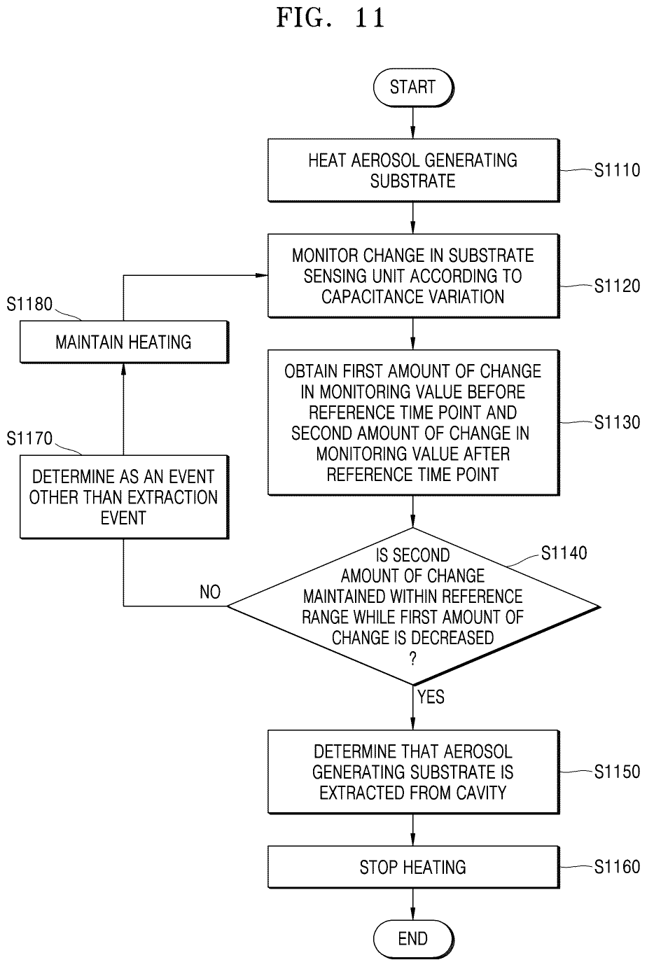

FIG. 11 is a flowchart illustrating an operating method of an aerosol generating device according to an embodiment.

Referring to FIG. 11, in operation S1110, the controller 12 may heat the aerosol generating substrate S by controlling power supplied to the heating unit 180.

When the aerosol generating substrate S is accommodated in the cavity, the capacitance of the substrate sensing unit 131 may vary, and the substrate sensing unit 131 may transmit a varied capacitance value to the controller 12. The controller 12 may determine, based on the capacitance value, whether or not the aerosol generating substrate S is accommodated in the cavity. When a monitoring value of the substrate sensing unit 131 is decreased by an amount greater than or equal to a reference decrease amount, the controller 12 may determine that the aerosol generating substrate S is inserted into the cavity.

When the aerosol generating substrate S is inserted into the cavity, the controller 12 may control the heating unit 180 to heat the aerosol generating substrate S.

In operation S1120, the controller 12 may monitor a change in the substrate sensing unit 131 according to a change in the capacitance of the substrate sensing unit 131.

The change in the substrate sensing unit 131 according to the change in the capacitance of the substrate sensing unit 131 may be expressed as a monitoring value. The monitoring value may include at least one or a combination of the capacitance value itself, the charging time, the discharging time, and the number of charge/discharge cycles.

In operation S1130, the controller 12 may obtain a first amount of change in the monitoring value before a reference time point and a second amount of change in the monitoring value after the reference time point.

The reference time point is a time point at which a sudden change in the monitoring value occurs and may refer to a time point at which an event occurs. The controller 12 may set the reference time point based on the monitoring value that is increased by an amount greater than or equal to a reference increase amount.

The controller 12 may set a monitoring section extending before and after a reaching time point, at which the amount of increase in the monitoring value reaches the reference increase amount, and including the reaching time point. The length from a start time point of the monitoring section to the reaching time point may be equal to the length from the reaching time point to an end time point of the monitoring section.

The controller 12 may set the time point at which the monitoring value reaches a maximum value in the monitoring section as the reference time point. Accordingly, the controller 12 may set a global peak as the reference time point.

The controller 12 may compare the change trends of the first amount of change in the first section and the second amount of change in the second section.

In operation S1140, the controller 12 may determine whether or not the second amount of change is maintained within a reference range while the first amount of change is decreased.

The first amount of change and the second amount of change may be linearly approximated, and the controller 12 may compare the first amount of change and the second amount of change, which have been linearly approximated, with a reference slope. The controller 12 may determine whether or not the first amount of change in the first section is less than the reference slope (however, in this case, the reference slope and the linearly approximated first amount of change are negative numbers), and whether or not the second amount of change in the second section is substantially flat.

In operation S1150, when the first amount of change is less than the reference slope and the second amount of change is substantially flat, the controller 12 may determine that the aerosol generating substrate S is extracted from the cavity.

In operation S1160, when the aerosol generating substrate S is extracted from the cavity, the controller 12 may stop the heating of the heating unit 180 by cutting off the power supplied to the heating unit 180.

In operation S1170, when the first amount of change and the second amount of change do not satisfy the conditions of operation S1140, the controller 12 may determine that the present event is an event other than an extraction event.

In an embodiment, when the first amount of change is gradually decreased over time in the first section and the second amount of change is gradually decreased over time in the second section, the controller 12 may determine that a user puff event has occurred.

In operation S1180, when an event other than an extraction event is sensed, the controller 12 may control the heating unit 180 to maintain the heating.

When the controller 12 controls the heating unit 180 to maintain the heating, the controller 12 may return to operation S1120 and continuously monitor a change in the substrate sensing unit 131. In other words, the controller 12 may monitor a change in the substrate sensing unit 131 according to a change in the capacitance of the substrate sensing unit 131.

When the capacitance sensor is arranged adjacent to the heating unit 180, the capacitance of the capacitance sensor is gradually decreased according to the heating of the heating unit 180. In particular, when the capacitance sensor is arranged between the induction coil 181 and the outer peripheral surface of the accommodation space, the capacitance sensor needs to be formed as a thin film and is affected by a magnetic field generated by the induction coil 181. Thus, it is difficult to set an absolute reference value that commonly applies to all capacitance sensors to determine whether or not the aerosol generating substrate S is extracted. The aerosol generating device 1 of the disclosure may compare changes in a monitoring value before and after a reference time point based on the reference time point, thereby solving the above-described issues and enabling more accurate detection of an extraction event.

Certain embodiments or other embodiments of the disclosure described above are not mutually exclusive or distinct from each other. Certain embodiments or other embodiments of the disclosure described above may be used together or combined with each other in configuration or function.

For example, configuration A described in a particular embodiment and/or drawing and configuration B described in another embodiment and/or drawing may be combined with each other. That is, even when the combination between the configurations is not directly described, the combination is possible unless it is described that the combination is impossible.

The above detailed description should not be construed as limiting in any respect and should be considered illustrative. The scope of the disclosure should be determined by a rational interpretation of the attached claims, and all changes within the equivalent scope of the disclosure are included in the scope of the disclosure.

The aerosol generating device of the disclosure may determine whether or not an aerosol generating substrate is extracted based on the amount of change in a sensor output value, rather than an absolute reference value of the sensor output value, and thus may more accurately sense whether or not the aerosol generating substrate is extracted from a cavity.

In addition, the aerosol generating device may determine whether or not the aerosol generating substrate is extracted based on the amounts of change in the sensor output value in sections before and after a reference time point, rather than simply using the amount of change in the sensor output value in any one section, and thus may more accurately sense whether or not the aerosol generating substrate is extracted from the cavity.

In addition, because the aerosol generating device accurately determines whether or not the aerosol generating substrate is extracted, the interruption and maintenance of heating that are not intended by a user may be eliminated, thereby increasing user satisfaction.

Effects of the disclosure are not limited to the above description, and further various effects are included in the present specification.

What is claimed is:

1. An aerosol generating device comprising:
a substrate sensing unit having a capacitance that varies according to insertion and extraction of an aerosol generating substrate with respect to a cavity;
a heating unit configured to heat the aerosol generating substrate when the aerosol generating substrate is inserted into the cavity; and
a controller configured to obtain a monitoring value of the substrate sensing unit according to a change in the capacitance of the substrate sensing unit and control the heating unit based on the monitoring value,
wherein the controller is further configured to, when the aerosol generating substrate inserted in the cavity is being heated, determine whether or not the aerosol generating substrate is extracted, based on a first amount of change in the monitoring value before a reference time point and a second amount of change in the monitoring value after the reference time point.

2. The aerosol generating device of claim 1, wherein the controller is further configured to set the reference time point based on the monitoring value that is increased by an amount greater than or equal to a preset reference increase amount.

3. The aerosol generating device of claim 2, wherein the controller is further configured to set a monitoring section extending before and after a reaching time point and including the reaching time point, the reaching time point being a time point at which the amount of increase in the monitoring value reaches the preset reference increase amount, and set a time point at which the monitoring value reaches a maximum value in the monitoring section as the reference time point.

4. The aerosol generating device of claim 1, wherein the controller is further configured to obtain the first amount of change in a first section selected between a first time point before the reference time point and the reference time point, and obtain the second amount of change in a second section selected between the reference time point and a second time point after the reference time point, wherein the first section and the second section have a same length.

5. The aerosol generating device of claim 4, wherein the controller is further configured to, when the first amount of change is gradually decreased over time in the first section and the second amount of change is maintained within a reference range in the second section, determine that the aerosol generating substrate is extracted from the cavity.

6. The aerosol generating device of claim 4, wherein the controller is further configured to, when the first amount of change is gradually decreased over time in the first section and the second amount of change is gradually decreased over time in the second section, control the heating unit to maintain a state in which the aerosol generating substrate is heated.

7. The aerosol generating device of claim 1, wherein the substrate sensing unit comprises at least one electrode arranged on an insulating substrate, and the monitoring value comprises at least one of a charging time, a discharging time, a number of charge/discharge cycles, and a capacitance value of the at least one electrode.

8. The aerosol generating device of claim 7, wherein the heating unit comprises:
an induction coil configured to generate an alternating magnetic field and surrounding an outer peripheral surface of an accommodation space in which the aerosol generating substrate is accommodated; and
a susceptor arranged in the accommodation space and heated by the alternating magnetic field, and
the substrate sensing unit is arranged between the outer peripheral surface of the accommodation space and the induction coil.

9. The aerosol generating device of claim 1, wherein the controller is further configured to control the heating unit to heat the aerosol generating substrate in a preheating section and a smoking section after the preheating section, and determine whether or not the aerosol generating substrate is extracted from the cavity in the smoking section.

10. The aerosol generating device of claim 1, wherein the controller is further configured to, when the aerosol generating substrate is extracted from the cavity, cut off power supplied to the heating unit.
